(19) United States
(12) Patent Application Publication
(10) Pub. No.: US 2009/0088912 A1
(43) Pub. Date: Apr. 2, 2009

(54) LINEAR DRIVEN X-Z ROBOT

(75) Inventor: Devarajan Rajaraman, Melville, NY (US)

Correspondence Address: AMIN TUROCY & CALVIN, LLP;ATTENTION: HEATHER HOLMES, 127 Public Square, 57th Floor, Key Tower, Cleveland, OH, 44114, US

(73) Assignee: ANORAD CORPORATION, Shirley, NY (US)

(21) Appl. No.: 11/864,796

(22) Filed: Sep. 28, 2007

(51) Int. Cl. G05D 3/00; B25J 18/02; B65G 1/133

(52) U.S. Cl. 701/19; 414/589; 74/490.01; 901/16

(57) ABSTRACT

Systems and methods of positioning a tool using a linear motor with a plurality of stages on a single path. A single rail and a plurality of trucks containing stages can comprise a linear motor. The trucks can connect to a tool through a linkage such as a four bar linkage or a scissor jack. The global position of the stages can be manipulated to effectuate motion along the path; the relative position, velocity, and acceleration of the trucks can be manipulated to effectuate motion in another direction such as a direction perpendicular to the path.

### BACKGROUND

Manufacturing in today's economy relies heavily on automated, controlled elements such as robotic arms, conveyors, and the like. Frequently, such elements are utilized as part of an assembly line, where the manufactured product is moved along a path from start to finish, and the many manufacturing elements perform actions on the product. Some actions are minor such as a small rotation or movement; other actions are greater in magnitude such as cutting, milling, pressurizing, and packaging the product. Existing equipment that facilitates this method of production implements pulleys, screws, belts, and other mechanical equipment to push, pull, rotate, and otherwise manipulate a product as it moves along the assembly line.

It is commonly advantageous for elements in an assembly or packaging line to be capable of movement in more than one dimension. For example, to pick up a product and move it to another location, a belt is commonly used to move a hook or grapple along in one direction and position the hook above the product. Then, a series of pulleys is typically used to lower the hook to the product and grasp the product; the pulleys once again are used to raise the product, and finally the belt engages a second time to move the product. This is a simple illustration of how increasing degrees of motion increases the capabilities of an assembly or packaging line, while at the same time increases the complexity of such elements.

In addition to the increased complexity of multi-directional movement, there is an increased need for moving parts. The size of such systems can grow inordinately large, effectively limiting the effectiveness of such complex systems. Nevertheless, the increased demands on manufacturers of today has required many companies to implement multi-axis assembly equipment.

### SUMMARY

The following presents a simplified summary of the invention in order to provide a basic understanding of some aspects of the innovation. This summary is not an extensive overview of the innovation. It is intended to neither identify key or critical elements of the innovation nor delineate the scope of the innovation. Its sole purpose is to present some concepts of the innovation in a simplified form as a prelude to the more detailed description that is presented later.

A linear motor driven, linear positioning system is provided including a plurality of trucks that can move along a single rail. The rail and the trucks can comprise a linear motor. The trucks connect to a tool by a plurality of arms (e.g., a four-bar linkage, a scissor jack). Motion of the two trucks together in a global sense moves the tool along the path; relative motion of the trucks causes the tool to move in another direction, such as perpendicular to the path of the trucks. The angular position of the arms can be manipulated to cause tilting or other desirable (or to prevent undesirable) motion of the tool.

A control component can interact with sensors such as positional sensors and accelerometers and the like to control the global and relative motion of the trucks to prevent overrun. In addition, mechanical limiters can be employed to prevent the trucks from exceeding minimum or maximum safe distance limits. A spring, damper, or other energy absorbing device can be placed strategically to minimize damage in the event of a collision.

In an aspect, air bearings can be used to support the trucks upon the rail, providing a clean, substantially noise-free working environment in which the tool can operate. In an environment such as a food-packaging environment where oil and other contaminants are common but harmful, the subject disclosure provides an advantageous system. Maintenance of the system is minimal due to the ease with which the trucks can be replaced. Down-time is also minimized because of the ease of replacing the trucks.

To the accomplishment of the foregoing and related ends, the invention then, comprises the features hereinafter fully described and particularly pointed out in the claims. The following description and the annexed drawings set forth in detail certain illustrative aspects of the innovation. These aspects are indicative, however, of but a few of the various ways in which the principles of the innovation may be employed; the subject innovation is intended to include all such aspects and their equivalents. Other objects, advantages, and novel features of the innovation will become apparent from the following detailed description of the innovation when considered in conjunction with the drawings.

### BRIEF DESCRIPTION OF THE DRAWINGS

FIG. 1 illustrates a linear motor driven positioning system with a plurality of stages on a single path.

FIG. 2 is an exemplary block diagram of a control component, an artificial intelligence component used in conjunction with a linear motor driven, linear positioning system.

FIG. 3 is a depiction of an alternative design of connecting arms between the stages of a linear positioning system and tooling.

FIG. 4 is a top view of a linear motor driven, linear positioning system.

FIG. 5 is a rendering of a linear motor driven positioning system where the angular position of the connecting arms can be selectively manipulated in order to tilt the tooling and payload as desired.

FIG. 6 depicts mechanical and control-system based limiters that restrict motion of the stages to within safe limits.

FIG. 7 is an illustrative flow chart diagram of a methodology that facilitates positioning tooling over a target and acquiring the target with the tool.

FIG. 8 is an illustrative flow chart diagram of a methodology that facilitates avoidance of undesirable motion of stages, both relative and global stage movement.

FIG. 9 illustrates an exemplary environment where various aspects of the subject innovation can be implemented.

FIG. 10 illustrates a further exemplary environment wherein aspects of the innovation can be implemented.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

As used in this application, the terms “component” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity. Furthermore, all or portions of the subject innovation may be implemented as a method, apparatus or article of manufacture using standard programming and/or engineering techniques to produce software, firmware, hardware, or any combination thereof to control a computer to implement the disclosed innovation.

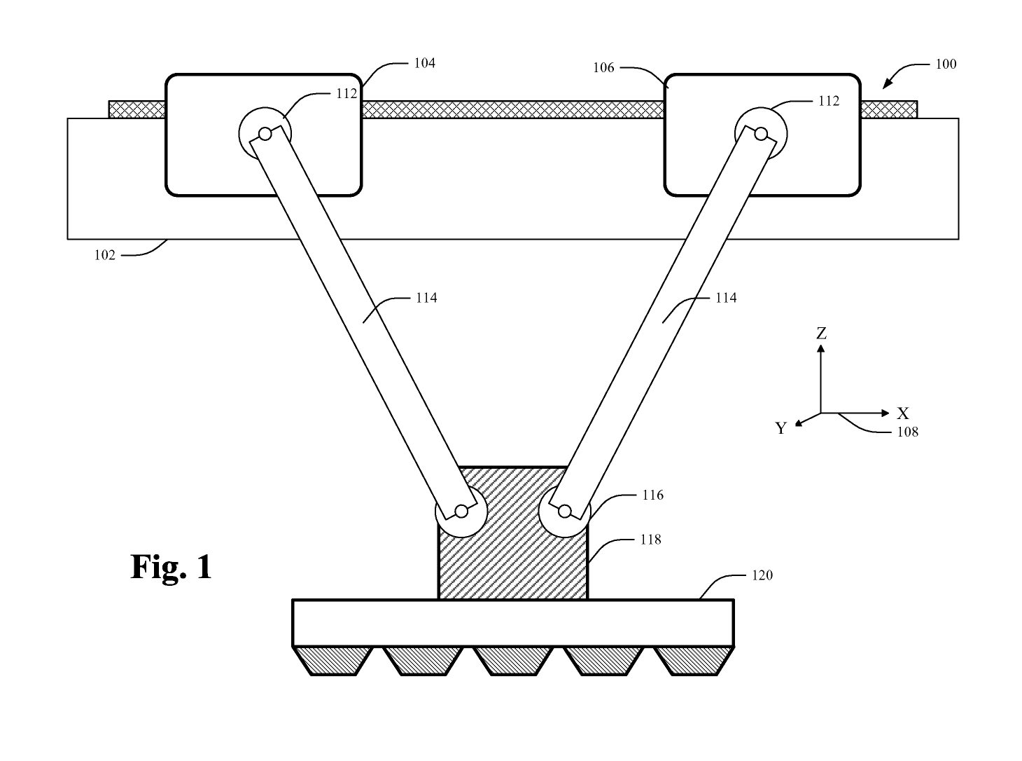

FIG. 1 depicts a positioning system 100 that implements a single axis, linear motor driven, linear stage. Rail 102 provides the primary source of guidance for the movement of the stage, and can be constructed of substantially any length. FIG. 1 reflects a small portion of the rail 102 for purposes of illustration. As with all components illustrated herein, rail 102 is not necessarily to scale, and is shown for illustrative purposes only. Rail 102 can be positioned advantageously over a product assembly, manufacturing, or packaging line. In an aspect, rail 102 is substantially straight; however, one of ordinary skill in the art will appreciate that rail 102 can take a curvilinear shape as required or prudent in a given application. Rail 102 can include a path for use as a linear electrical motor. In an aspect, the linear motor is an iron core attract force motor, with two trucks 104 and 106, serving as stages that can travel back and forth in the X direction (as defined by axis 108) along the rail 102. In another aspect, the rail 102 can contain the windings and the trucks 104 and 106 contain U-shaped magnet channels, forming a zero attraction force balanced-type motor. In either case, Trucks 104 and 106 and rail 102 together form a single axis, linear motor driven, linear positioning system 100. Communication path 110 can extend along rail 102 and can be in electrical communication with trucks 104 and 106 to convey instructions and electrical power as required to operate the positioning system 100.

Each truck 104 and 106 contains an upper pivot 112, an arm 114, and a lower pivot 116. Tooling 118 connects to lower pivot 116, which can act upon payload 120. Tooling 118 and payload are herein described in generic terms; substantially any type of tooling 118 can be adapted for use with the subject innovation, and can be chosen to accommodate a payload 120 of varying size, shape, and weight, depending on the application (e.g., a hook, a mechanical hand, a loop, a suction cup, a bolt). Payload 120 is also represented in the general case; any object that tooling 116 can be directed to act upon can comprise the payload 120.

Conventional linear motors employ a single stage on a path, limiting motion to one-dimensional, back and forth movement. The subject disclosure employs a plurality of stages on a single rail 102, granting the system 100 the ability to move in the Z direction. In an aspect, upper pivots 112 allow free rotation of arms 114 with respect to trucks 104 and 106. Rail 102, trucks 104 and 106, and tooling 118, therefore comprise a four-bar linkage, whose mechanical operation and utility is well documented in the art. Rail 102 and trucks 104 and 106 provide an extra degree of freedom because of relative movement in the X-direction of trucks 104 and 106. Thus, motion in two dimensions is achieved with only controlled motion of two objects (trucks 104 and 106) in one direction. The result is a positioning system of reduced complexity and cost that nevertheless provides the benefits of a more complex device.

In an aspect, the subject innovation can employ various types of bearings between trucks 104 and 106 and rail 102, or between any other component of the system 100. Fluid bearings, such as air bearings, can be employed. Unlike contact-roller bearings, air bearings utilize a thin film of pressurized air to provide a near zero-friction load-bearing interface between surfaces. The fluid film of the bearing can be air that flows through the bearing itself to the bearing surface. The design of the air bearing can be such that, although the air constantly escapes from the bearing gap, the continual flow of pressurized air through the bearing is enough to support the working loads. Contact between the two surfaces is minimal or non-existent, avoiding the traditional bearing-related problems of friction, wear, particulates, and lubricant handling, and offer distinct advantages in precision positioning and high-speed applications. In particular, a clean packaging environment is easily contaminated by emissions and spillages that are the common by-product of oil or other fluid or contact bearings—air bearings avoid this problem altogether. Moreover, air bearings produce little or no appreciable noise during operation, which may be desirable or required for a given application. An additional benefit is the ease with which a faulty truck can be replaced with a new truck. In a matter of minutes the system 100 can be repaired and operational.

FIG. 1 shows a horizontal configuration of the subject innovative assembly; however, the system can be configured in a variety of angles and directions, depending on the needs of a particular application. In an aspect, the rail 102 can be positioned to run vertically. Trucks 104 and 106 then can travel up and down the rail 102 and effectuate the same relative motion as described above. For example, filling a bag of potato chips can be accomplished with the rail 102 positioned vertically. The bags can be formed from a long web of material that passes vertically adjacent to tooling 118. Relative motion of the trucks 104 and 106 can be directed to cause tooling 118 to engage a portion of the web, and move away from the web to open the bag. The bag can then be filled, and then relative motion of the trucks 104 and 106 can cause the bag to close and be sealed. The process can repeat as needed to fill the bags. This specific example of the functionality of the subject innovation is given to illustrate the wide variety of configurations and applications that are possible with the subject innovation.

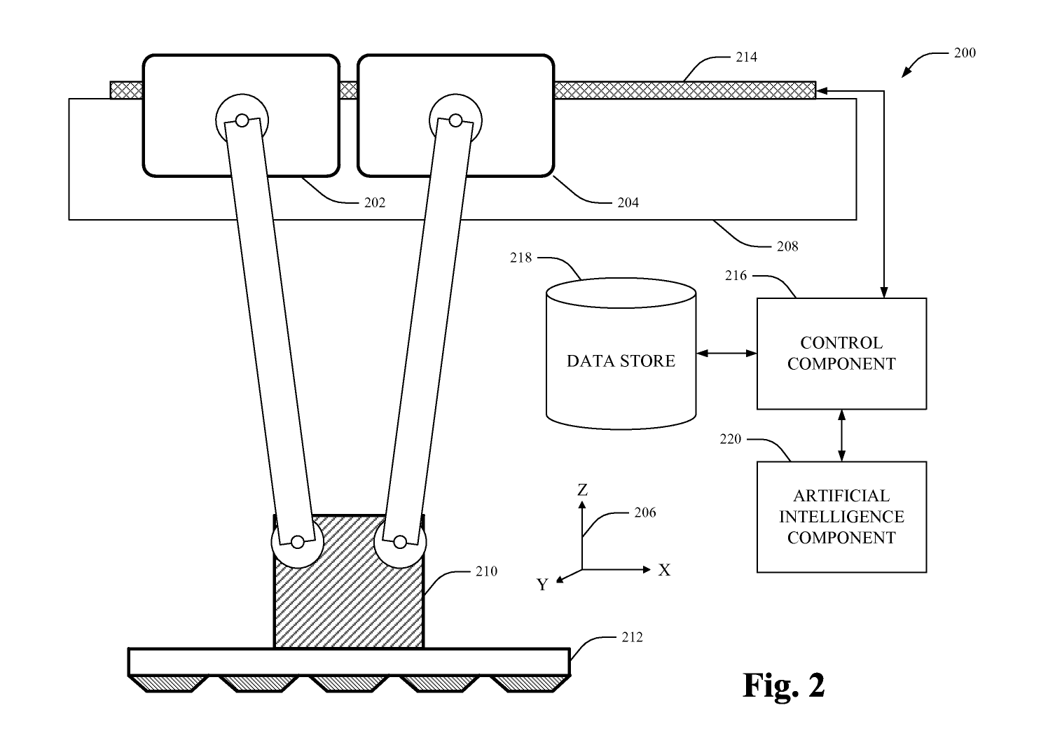

FIG. 2 illustrates a positioning system 200 that uses a linear motor with two stages. Trucks 202 and 204 have been moved together in the X-direction (according to axis system 206) along rail 208 to lower the tooling 210 and the payload 212 in the Z-direction. Communication path 214 can provide electrical and informational communication between trucks 202 and 204 and a control component 216. The position, speed, and acceleration of the trucks 202 and 204 can be controlled according to known techniques by the control component 216 in order to move the trucks 202 and 204 together forward or backward along the rail 208, or relatively to move tooling 210 (and attached payload 212, if any) upward and downward in the Z direction. Trucks 202 and 204 can both be moved toward or away from each other, or one can be held stationary while the other moves. Which truck to move, and how far to move it, depends on the desired position of the tooling 210 and payload. As shown, truck 204 has been moved toward truck 202, as compared to their relative positions in FIG. 1, and the tooling 210 and payload 212 have accordingly moved downward and to the left (or in the negative X-direction).

Data pertaining to the control and motion of trucks 202 and 204 can be stored in a data store 218, containing volatile memory or nonvolatile memory, or a combination thereof. In one example, nonvolatile memory can include read only memory (ROM), programmable ROM (PROM), electrically programmable ROM (EPROM), electrically erasable ROM (EEPROM), or flash memory. The memory can include removable memory such as Compact Flash cards, Secure Digital cards, and the like. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The data store of the subject systems and methods is intended to comprise, without being limited to, these and any other suitable types of memory.

In an aspect of the subject innovation, an artificial intelligence component 220 can be employed to assist with controlling the global and relative position of the trucks 202 and 204, and therefore also the position of the tooling 210 and the payload 212. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

For example, in connection with controlling the position of the trucks 202 and 204, the subject innovation can employ various artificial intelligence schemes. A process for learning explicitly or implicitly the relative and/or global position of the trucks 202 and 204 can be facilitated via an automatic classification system and process. Classification can employ a probabilistic and/or statistical-based analysis (e.g., factoring into the analysis utilities and costs) to prognose or infer an action that a user desires to be automatically performed. For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class). As shown in FIG. 2, an artificial intelligence (AI) component 220 can be employed to facilitate inferring and/or determining when, where, how to move trucks 202 and 204 along rail 208 relative to one another, or globally. The AI component 220 can employ any of a variety of suitable AI-based schemes as described supra in connection with facilitating various aspects of the subject innovation.

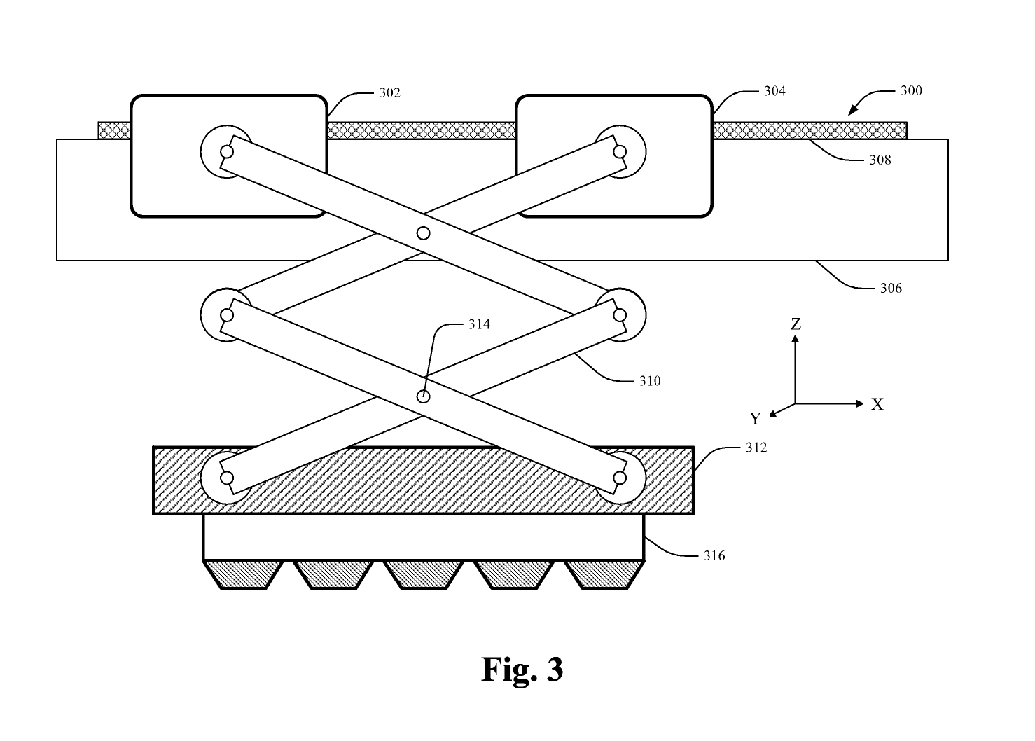

FIG. 3 represents a positioning system 300 including components similar to those shown in FIGS. 1 and 2. Trucks 302 and 304 can move along rail 306 as guided by instructions and perhaps power delivered through communication path 308. In this embodiment, a plurality of arms 310 are used to increase the range of motion in the Z-direction. As will be appreciated by one of skill in the art, arms 310 can operate as a scissor jack mechanism. As will also be understood, this configuration is merely one of several possible arm configurations that can be implemented in accordance with the subject innovation. The specific examples shown herein are for illustrative purposes only; the subject innovation is not limited to the configurations shown in any way. For example, tooling 312 can attach to arms 310 at the midpoint pin 314, rather than at the end of an arm, as shown in FIG. 3, without departing from the spirit of the subject innovation.

While FIGS. 1 and 2 are limited in the distance of travel in the Z-direction to the length of the arms (element 114 in FIG. 1), implementing multiple arms allows a smaller motion of the trucks to effectuate a larger vertical path. In the case of a scissor jack configuration, the number of arm pairs is the multiple that is applied to the X-direction path that must be traveled by the trucks 302 and 304 (note also that the number of arm pairs need not be an integer value). Depicted in FIG. 3 are two arm pairs, so the motion of the trucks 302 and 304 results in a two-fold increase in vertical path of the tooling 312 and payload 316. Choice of configuration can depend on the circumstance, and can vary widely at the discretion of an engineer of skill in the art.

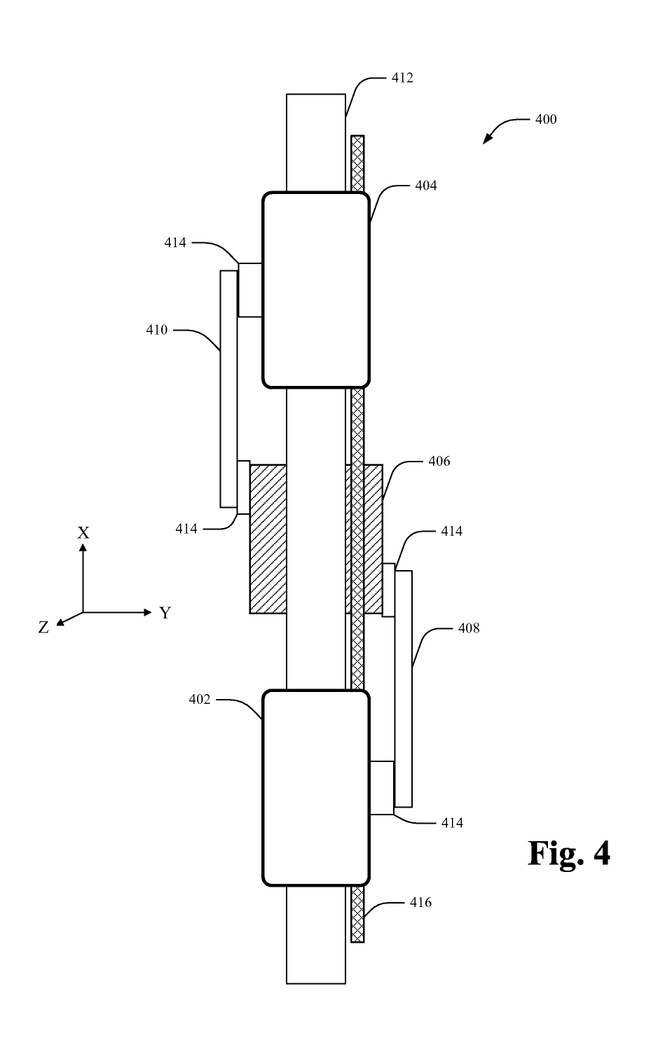

FIG. 4 illustrates a top view of an embodiment according to the subject innovation in which a linear motor driven, linear positioning system 400 is utilized. Trucks 402 and 404 can be configured to connect to tooling 406 by arms 408 and 410, which extend from the trucks on opposite sides of the rail 412. In this manner, the weight of the tooling is balanced in the Y-direction, which reduces the stress in the joints 414, and reduces energy requirements associated with counter-acting an imbalanced tooling configuration. The joints 414 between the arms 408 and 410 and the tooling 406, as well as between the arms 408 and 410 and the trucks 402 and 404 are also eased by balancing the weight. It is to be appreciated that this configuration assumes an even weight distribution on the tooling, and that if the weight of the tooling or the payload was off-center with respect to the rail 412 (in the Y-direction), another support structure could be chosen to accommodate the imbalance, and still capture the benefits of a balanced system. Of course, perfect balance is ideal and rare, so the joints 414 between the various components can be dimensioned to mitigate inefficiencies and difficulties due to an imbalanced load. Communication path 416 facilitates communication between the trucks 402 and 404 and a control system that can assist with imbalanced conditions. Sensors (not shown) can be employed to detect an imbalanced load from stress in the joints 414, or another location. This information can be passed back to the control system which can direct alterations to the joints 414 to center the load if the stress levels are sufficiently high. An example of a possible alteration is extending the joints 414, the arms 410 and 408 and tooling 406 in the Y-direction to center the weight, or at least reduce the moment arm caused by the imbalance.

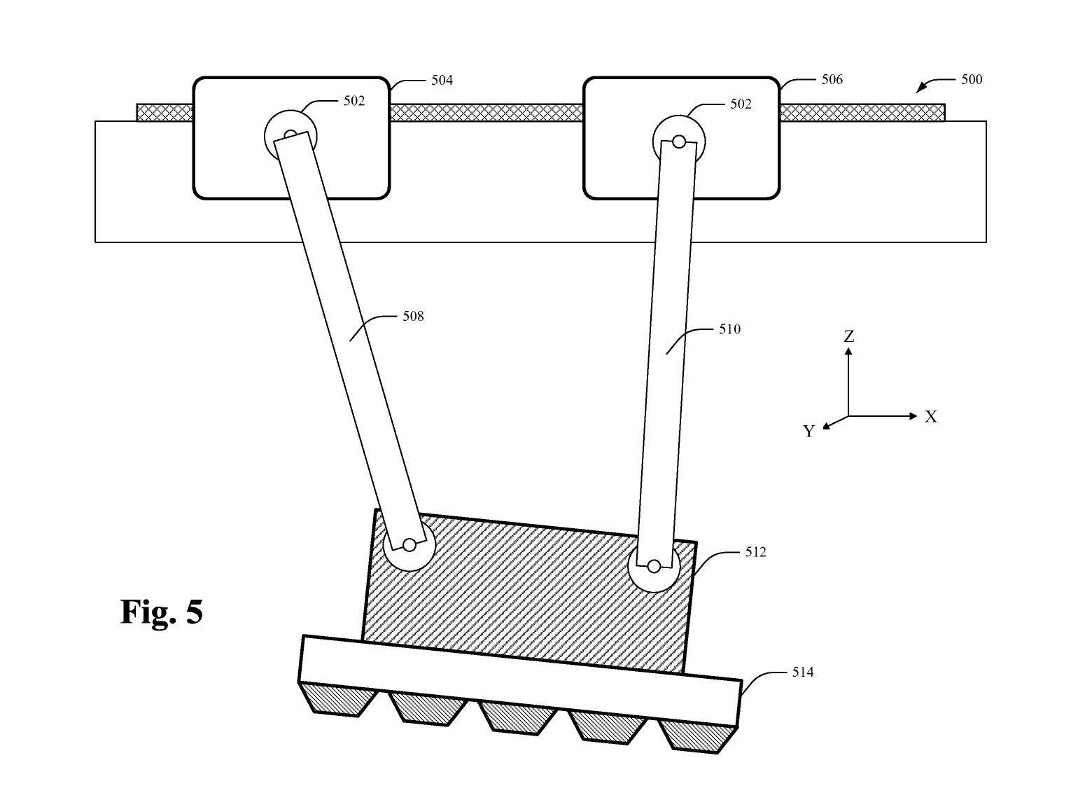

FIG. 5 depicts a positioning system 500 that employs a linear motor with two stages or trucks to effectuate motion in the X as well as the Z direction. In an aspect, joints 502 between trucks 504 and 506 can include means to control the angular position of arms 508 and 510, either simply by preventing rotation, or by actively supplying power to the arms to rotate them relative to the joint 502. In combination with movement in the X-direction of truck 506 relative to truck 504, this feature allows tooling 512 and payload 514 to tilt about the Y-axis, as shown. In this example, joint 502 between truck 504 and arm 508 has inhibited rotation of arm 508, while truck 506 moves toward truck 504 and the remaining joints 502 allow free rotation. Tilting the tooling 512 and payload 514 provides an additional degree of freedom with only a marginal increase in complexity and cost to the system 500. Effective tilting can be accomplished using a simple brake assembly or other equivalent mechanism to inhibit rotation of one or more of the components and tilting can be achieved.

A slightly more complex situation, involving a powered mechanism to drive the angular position of the arms, is also feasible and poses minimal cost increases while providing high flexibility and movement. Tilting can be advantageous at various stages of a packaging line: during product pick up, to maneuver through a tight area, or while dropping the product. As will be understood, tilting provides another degree of freedom, which can be judiciously exploited by an engineer of skill in the art. It is also to be appreciated that the tilting motion shown in FIG. 5 is illustrative of the type of motion that is easily achieved with the subject innovation, and other, similar manners of tilting and rotation are possible without departing from the scope of the present invention.

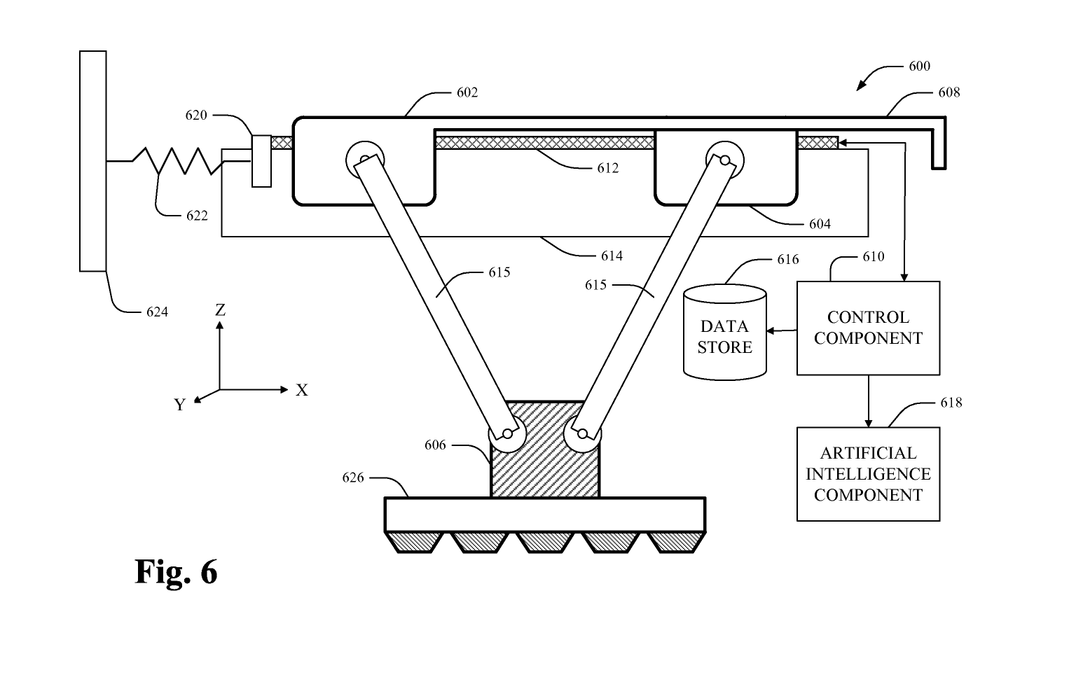

FIG. 6 depicts a positioning system 600 that can prevent undesirable results caused by errant relative motion of certain components of the system 600. Similar to the systems described above, positioning system 600 can employ trucks 602 and 604 that can move together or independently to position tooling 606 in the X and Z directions. As described previously, motion of trucks 602 and 604 away from one another can act to elevate tooling 606 in the Z-direction; however, excessive distance between the trucks 602 and 604 can cause failure and other undesirable results. In order to prevent such results, mechanical and control restrain mechanisms can be employed. A mechanical limiter 608 can be attached to at least one truck 602 that can engage another truck 604 to physically limit the distance between the two. A similar limiter 608 can be applied to both trucks 602 and 604; also, other types of mechanical limiters can be employed to reach the same effect. It is to be appreciated that the dimensions and configurations of the mechanical limiters shown herein are merely for illustration, and the subject innovation is not limited to the examples shown.

In addition to, or in place of a mechanical limiter 608, a control system 610 can be utilized to prevent trucks 602 and 604 from exceeding a safe distance. The global and relative position, velocity, acceleration of the trucks 602 and 604, as well as other characteristics such as mass, friction resistance, and the like can be communicated to the control system 610 through the communication path 612. Sensors such as accelerometers and piezoelectric sensors can be placed in the rail 614 and/or on the trucks 602 and 604 to help to gather the information needed to prevent overrun such as position on the rail 614, angular position of the arms 615, and the like. This data can be stored in a data store 616, and in conjunction with an artificial intelligence component 618, trucks 602 and 604 can be prevented from exceeding a safe relative distance. If the control component 610 detects (or infers) that one truck 602 or 604 is behaving erratically and will likely move beyond a safe distance from the other truck, relative motion can be prevented by braking one or both trucks, or by moving one or more trucks in a direction that will prevent overrun. It is to be appreciated that the mechanical limiter 608 and software-based limiters such as control system 610 can be used independently or in conjunction to prevent damage to the system 600, as required or prudent in a given application.

Besides relative distance between trucks, another potential danger is exceeding the length of the rail 614. A bumper 620, connected to a spring 622 or other energy-absorbing device, can be placed between the trucks 602 and 604 and the end 624 of the rail, and/or between the two trucks. The size and energy absorbing characteristics of the spring 622 can depend on the mass of the trucks 602 and 604, the tooling 606, and the payload 626, if any. It is to be appreciated that dampers and springs and their equivalents can be employed to prevent damage to the system 600 caused by a collision with the rail end 624, or between the two trucks. Moreover, control system 610 can also be utilized to prevent such a collision, as with relative distance control as described above. Further, other objects may appear along the path of the trucks 602 and 604 and similar mechanical and/or control-based techniques can be employed to avoid (or cause, as the case may be) contact with such objects.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems and methods may include or consist of machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

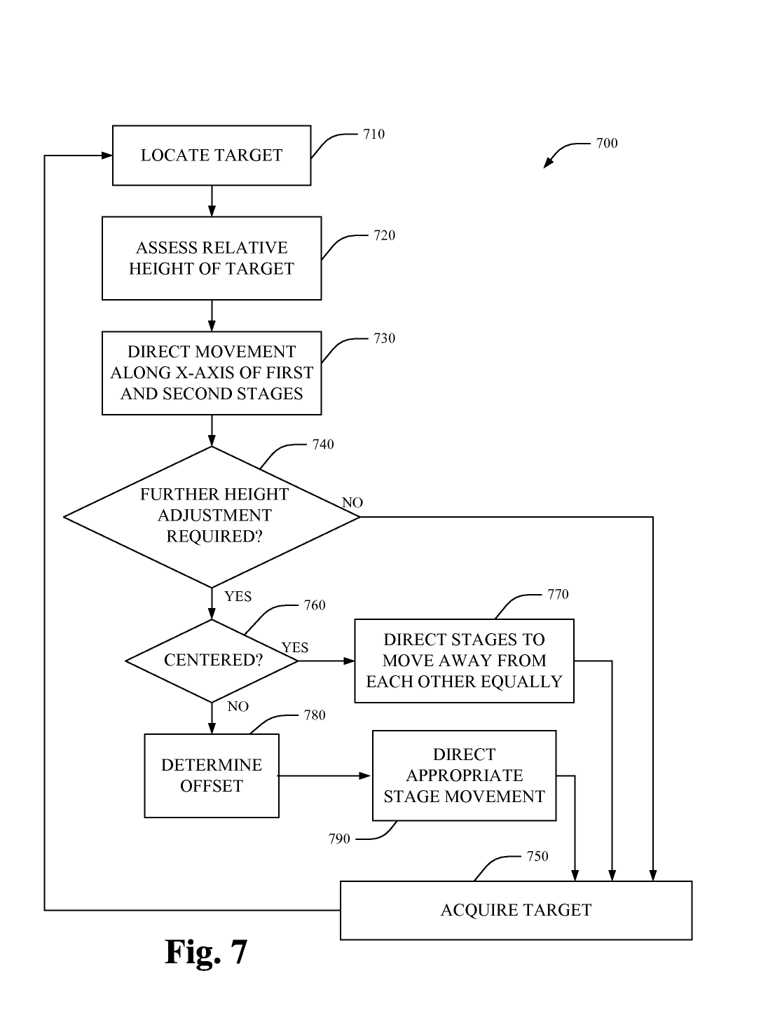

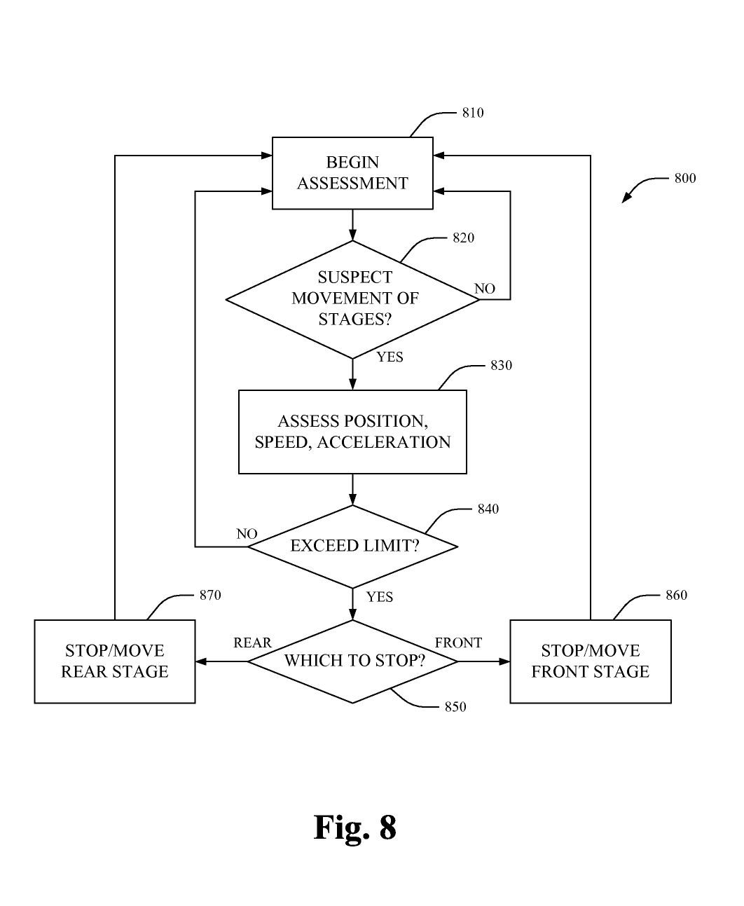

In view of the illustrative systems described supra, methodologies that can be implemented in accordance with the disclosed subject matter will be better appreciated with reference to the flow charts of FIGS. 7 and 8. While for purposes of simplicity of explanation, the methodology is shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodology described hereinafter.

FIG. 7 represents a methodology 700 employing a linear motor driven, linear positioning system. As depicted in FIGS. 1-6, the positioning system can utilize a tool, connected to plurality of stages by a plurality of arms, with the stages mounted on a single path. At reference numeral 710, a target is located. The target can be any object toward which the tool can be directed to perform some action such as picking up the object, moving the object, delivering something to or near the object, and so forth. It is to be appreciated that the specific act (if any) that the tool performs on the target can be any appropriate act. As understood by one of ordinary skill in the art, the subject disclosure is not limited to a specific tool configuration or action. The target information can be obtained from a control system or other automation oversight source. Information such as distance to the object, weight, size, and other descriptive information can be obtained and used to carry out the desired action on the target. At reference numeral 720, the relative height of the target is assessed. As described with respect to FIG. 1-6, the Z-direction height of the tooling can be controlled by relative spacing of the plurality of stages. Therefore, the relative height is helpful to instruct the stages approximately how far apart they should be when they arrive at the target.

Once the target information is obtained, at reference numeral 730 the stages can be directed to move in the X-direction toward the target. If the height of the target indicates that the current position of the stages (and therefore the current height of the tool) does not need to change, then the stages can be directed to move the same distance toward the target. If, on the other hand, there is some height adjustment required, the stages can be directed to move in the same direction, but to move different distances so as to arrive at the target at the appropriate height. A center-to-center distance can be calculated, and an accommodating height-adjustment X-direction separation distance can be added to the front stage's travel, and subtracted from the rear stage's travel, as described by the following equations:

T_{front}=(CD−∂₁)+(∂₂/2)

Tᵣₑₐᵣ=(CD+∂₁)−(∂₂/2)

where T_{front} is the travel distance of the front stage, and Tᵣₑₐᵣ is the travel of the rear stage, CD is the center distance between the initial center point of the stage and the target center, and ∂₁ and ∂₂ are the X-direction distances between the stages in the initial and target positions, respectively, according to the appropriate Z-direction position of the tool.

At reference numeral 740, further height adjustment may be necessary to acquire the target. For example, if the target is held within a box or other packaging that the tool must pass over to arrive at the target, but must descend into to act upon the target, the highest point of the packaging can be the height initially adjusted to; however, once the tooling is over the target, further lowering of the tool may be required before the tool comes into contact with the target. If this is not the case and the target is within the tool's range, at reference numeral 750 the target is acquired and the process repeats. If, on the other hand, there is additional vertical (Z-direction) movement that must be effectuated, at reference numeral 760 the X-direction position of the tool with respect to the target can be assessed. If centered, at reference numeral 770, the stages can be moved apart equally an appropriate distance until target is acquired at reference numeral 750, and the process can repeat. If the tool and target are not centered in the X-direction, the offset can be determined at reference numeral 780, and appropriate stage movement can be directed at reference numeral 790 after which the target can be acquired, and the process can repeat. The same or similar process can be performed during pick-up or delivery of an object. If the tool picks up an object, the height of the object can be included in the height calculations to ensure that the object does not strike (or, that the object does contact) other objects during motion.

FIG. 8 depicts a methodology 800 employing a linear motor driven, linear positioning system, as described previously herein. Methodology 800 facilitates control and prevention of undesirable relative and/or global movement of the stages. At reference numeral 810, assessment can initiate. A variety of situations can cause initiation of an assessment—a control mechanism, a sensor detecting a met condition, or according to a schedule—all of which are contemplated in the subject methodology 800. At reference numeral 820, relative movement of stages is detected. As described above, relative movement of the stages can cause desirable vertical motion of a connected tool, but the limits of the connection mechanism between the stages and the tool cannot be exceeded without undesirable effects. Also, the path upon which the stages run may have limits which should be avoided for the same reasons. If there is no suspect movement between the stages, and the limits (if any) on the rails are not near, then the assessment can cease until a new assessment is begun.

However, if there is suspect movement, whether from excessive relative movement of the stages (toward or away from one another) or from approaching a rail limit, a more detailed assessment of the position, speed, and acceleration can be taken at reference numeral 830. A control system can determine whether this information indicates that a limit will be exceeded at reference numeral 840, and if no threat to the system is detected the assessment can cease until a new assessment is prudent. If the limit is or will be exceeded, at reference numeral 850 an assessment can be made of which stage, the front, the rear, or both stages, is appropriate to act upon. Depending on the circumstances, stopping one or both stages, or moving one or both stages, or any combination of stopping and moving can be implemented. For example, if a first stage is careening toward the second stage such that even with direct braking of the first stage contact between the two stages will occur due to the inertia of the first stage (and the tooling, payload, and any other component), in addition to braking the first stage, the second stage can nimbly move away from the first stage to avoid contact. It is to be appreciated by one of ordinary skill in the art that the particulars of an application of the subject methodology 800 will call for variations on the combination of braking and movement, and the like. At reference numeral 860, instructions to the front stage can be delivered; at reference numeral 870 instructions can be delivered to the rear stage, and the assessment can cease until initiated by another event.

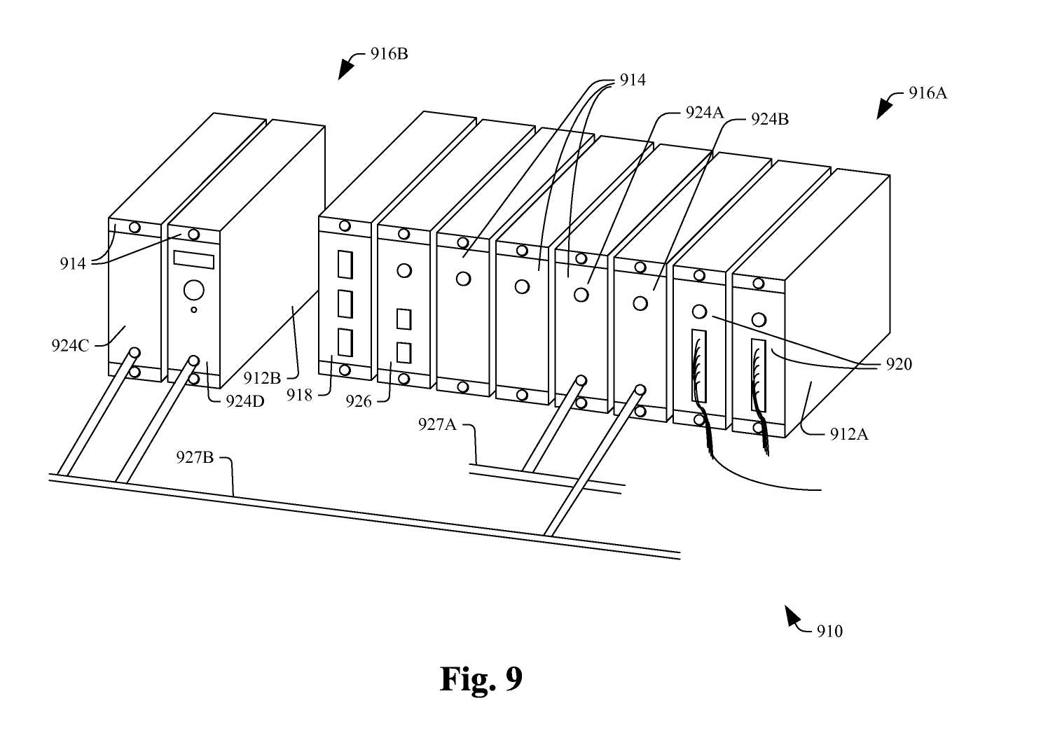

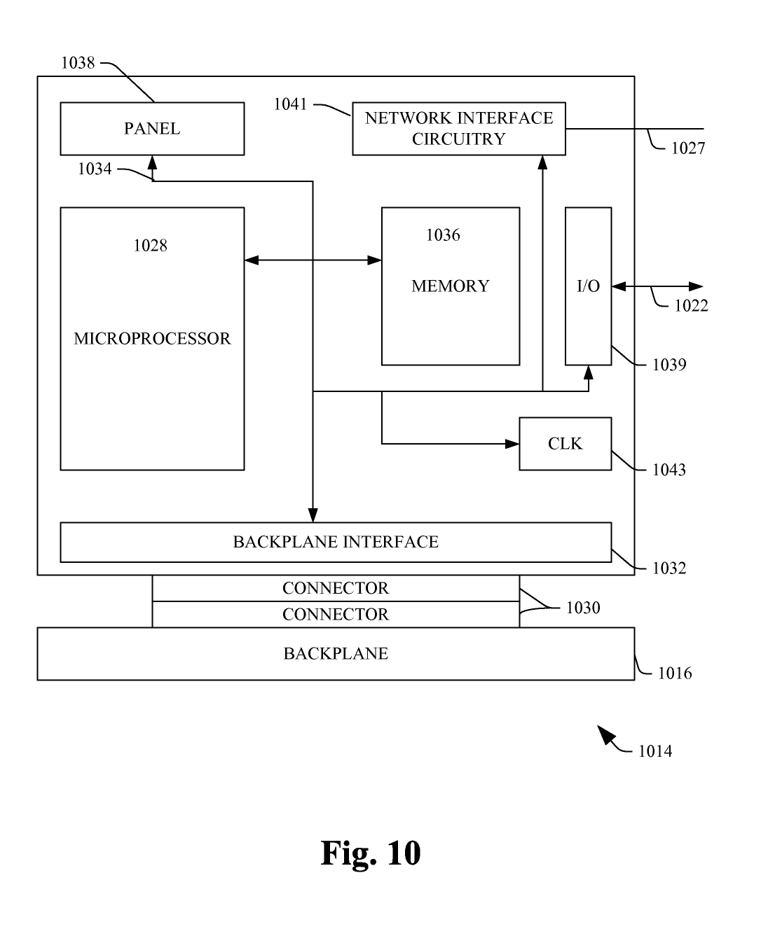

The methods and systems of the subject innovation can be employed in association with many forms of control systems. In order to provide context for the various applications in which the aspects of the innovation may be carried out, an exemplary control system is now illustrated and described with respect to FIGS. 9 and 10. However, it will be appreciated that the various aspects of the innovation may be employed in association with controllers and control systems other than those illustrated and described herein. A distributed industrial control system 910 suitable for use with the subject innovation provides a first and second rack 912A and 912B for holding a number of functional modules 914 electrically interconnected by backplanes 916A and 916B running along the rear of the racks 912A and 912B respectively. Each module 914 may be individually removed from the rack 912A or 912B thereby disconnecting it from its respective backplane 916 for repair or replacement and to allow custom configuration of the distributed system 910.

The modules 914 within the rack 912A may include, for example, a power supply module 918, a processor module 926, two communication modules 924A and 924B and two I/O modules 920. A power supply module 918 receives an external source of power (not shown) and provides regulated voltages to the other modules 914 by means of conductors on the backplane 916A. The I/O modules 920 provide an interface between inputs from, and outputs to external equipment (not shown) via cabling 922 attached to the I/O modules 920 at terminals on their front panels. The I/O modules 920 convert input signals on the cables 922 into digital words for transmission on the backplane 916A. The I/O modules 920 also convert other digital words from the backplane 916A to the necessary signal levels for control of equipment.

The communication modules 924A and 924B provide a similar interface between the backplane 916A and one of two external high speed communication networks 927A and 927B. The high speed communication networks 927A and 927B may connect with other modules 914 or with remote racks of I/O modules 920, controller configuration tools or systems, or the like. In the example illustrated in FIG. 9, the high speed communication network 927A connects with backplane 916A via the communication module 924A, whereas the high speed communication network 927B connects the communication module 924B with communication modules 924C and 924D in rack 912B. The processor module 926 processes information provided by the communication modules 924A and 924B and the I/O modules 920 according to a stored control program or routine, and provides output information to the communication module 924 and the I/O modules 920 in response to that stored program and received input messages.

Referring also to FIG. 10, each functional module 1014, is attached to the backplane 1016 by means of a separable electrical connector 1030 that permits the removal of the module 1014 from the backplane 1016 so that it may be replaced or repaired without disturbing the other modules 1014. The backplane 1016 provides the module 1014 with both power and a communication channel to the other modules 1014. Local communication with the other modules 1014 through the backplane 1016 is accomplished by means of a backplane interface 1032 which electrically connects the backplane 1016 through connector 1030. The backplane interface 1032 monitors messages on the backplane 1016 to identify those messages intended for the particular module 1014, based on a message address being part of the message and indicating the message destination. Messages received by the backplane interface 1032 are conveyed to an internal bus 1034 in the module 1014.

The internal bus 1034 joins the backplane interface 1032 with a memory 1036, a microprocessor 1028, front panel circuitry 1038, I/O interface circuitry 1039 (if the module is an I/O module 920) and communication network interface circuitry 1041 (if the module is a communication module 924). The microprocessor 1028 may be a general purpose microprocessor providing for the sequential execution of instructions included within the memory 1036 and the reading and writing of data to and from the memory 1036 and the other devices associated with the internal bus 1034. The microprocessor 1028 includes an internal clock circuit (not shown) providing the timing of the microprocessor 1028 but may also communicate with an external clock 1043 of improved precision. This clock 1043 may be a crystal controlled oscillator or other time standard including a radio link to an external time standard. The precision of the clock 1043 may be recorded in the memory 1036 as a quality factor. The panel circuitry 1038 includes status indication lights such as are well known in the art and manually operable switches such as for locking the module 1014 in the off state.

The memory 1036 may comprise control programs or routines executed by the microprocessor 1028 to provide control functions, as well as variables and data necessary for the execution of those programs or routines. For I/O modules 920, the memory 1036 may also include an I/O table holding the current state of inputs and outputs received from and transmitted to the industrial controller 910 via the I/O modules 920. The module 1014 may be adapted to perform the various methodologies of the innovation, via hardware configuration techniques and/or by software programming techniques.

Although the innovation has been shown and described with respect to certain illustrated aspects, it will be appreciated that equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the innovation. In this regard, it will also be recognized that the innovation includes a system as well as a computer-readable medium having computer-executable instructions for performing the acts and/or events of the various methods of the innovation.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A linear motor drive, linear positioning system, comprising:
a rail that defines the path of motion of the positioning system;
a first truck and a second truck that together with the rail define a linear motor;
a plurality of arms that extend between the first and second trucks to a tool, relative motion of the first and second trucks causes motion of the tool in a direction substantially perpendicular to the path of motion of the positioning system.

2. The system of claim 1, further comprising a control component that controls the relative motion of the trucks.

3. The system of claim 2, the control component prevents the first and second trucks from exceeding at least one of a minimum or a maximum relative distance along the path.

4. The system of claim 2, the control component prevents the trucks from undesirable contact with and end of the rail.

5. The system of claim 1, coordinated motion of the first and second trucks causes movement in a direction along the path of motion of the positioning system.

6. The system of claim 1, the arms comprise substantially rigid connectors that are rotatably connected to the trucks at one end, and to the tool at another end.

7. The system of claim 1, the arms comprise a plurality of substantially rigid members that comprise a scissor-jack mechanism.

8. The system of claim 1, the relative motion of the first and second trucks, the arms, and the tool comprise a four bar linkage.

9. The system of claim 1, the arms are rotatable connected to the first and second trucks, the angular position of the arms is selectively fixed with respect to the trucks.

10. The system of claim 1, further comprising a mechanical limiter that limits motion of the first and second trucks from exceeding at least one of a minimum or maximum relative distance.

11. The system of claim 10, further comprising a control component that prevents the trucks from exceeding at least one of maximum or minimum relative distance.

12. The system of claim 11, the control component senses at least one of position, velocity, or acceleration of at least one of the first or second trucks to prevent exceeding at least one of maximum or minimum relative distance.

13. The system of claim 1, the rail comprises a magnetic path and the trucks comprise the stages to form an iron core, attraction force linear motor.

14. The system of claim 1, the rail includes the windings and the trucks include U-shaped magnetic channels to form a zero attraction force, balanced type linear motor.

15. A method of positioning a tool using a linear motor driven, linear positioning system with a plurality of stages on a single path, comprising:
determining a target and a location of the target, the location of the target comprising a distance in an X-direction along the path and a Z-direction;
determining a relative Z-direction height difference (Ah) between a current position and the target;
determining a center-to-center distance (AC) between the current position and the target;
directing movement of a front stage the distance ΔC+(∂/2), and a rear stage a distance ΔC+(∂/2), where ∂ is an X-direction difference between the stages that produces the height difference Δh.

16. The method of claim 15, the X-direction and the Z-direction are substantially perpendicular.

17. The method of claim 15, further comprising directing the front and rear stages to move to alter the Z-direction position to acquire the target.

18. The method of claim 15, further comprising directing relative movement of the stages to account for obstacles in the path.

19. The method of claim 15, further comprising manipulating an angular position of an arm that connects at least one of the front and rear stage to a tool.

20. A system for positioning a tool relative to an object, comprising:
means for positioning a first stage along a linear path;
means for positioning a second stage along a linear path;
means for connecting the first and second stages to a tool, global movement of the first and second stages in a first direction moves the tool in the first direction, and relative movement of the first and second stages moves the tool in a second direction; and
means for acting upon the object.
